(19) United States
(12) Patent Application Publication
(10) Pub. No.: US 2018/0108507 A1
(43) Pub. Date: Apr. 19, 2018

(54) FUSE ELEMENT AND METHOD OF FABRICATION

(71) Applicant: GM GLOBAL TECHNOLOGY OPERATIONS LLC, Detroit, MI (US)

(72) Inventors: Tyson W. BROWN, Royal Oak, MI (US); Yue FAN, Ann Arbor, MI (US); Derek W. FULTZ, Royal Oak, MI (US)

(21) Appl. No.: 15/293,411

(22) Filed: Oct. 14, 2016

(51) Int. Cl. H01H 85/143; H01H 69/02; H01H 85/18

(52) U.S. Cl. CPC H01H 85/143; H01H 85/18; H01H 69/02

(57) ABSTRACT

A method of fabricating a fuse includes providing a fuse element within a casing. The fuse element has a plurality of ligaments configured to direct a current therethrough. A mechanical tension is then applied to the fuse element and a filler material is added to the casing so as to support the fuse element. The filler material is then solidified. Next, the mechanical tension is removed with the fuse element retaining a residual tensile stress after removal of the mechanical tension.

### FIELD

The present disclosure relates to a fuse element and a method of fabrication for improving fatigue life thereof.

### INTRODUCTION

The statements in this section merely provide background information related to the present disclosure and may not constitute prior art.

Fuses are often used as a failsafe for current overload in various applications. When these fuses are loaded under varying current demands, cyclic temperature and stress can lead to premature fatigue or mechanical failure of the fuse. Electric, hybrid, fuel cell and many other types of vehicles use battery packs as a source of electrical energy for driving the vehicles. These vehicles employ a fuse system to provide an automatic interruption of power in the event of excessive current flow.

### SUMMARY

A method of fabricating a fuse includes providing a fuse element within a casing. The fuse element has a plurality of ligaments configured to direct a current therethrough. A mechanical tension is applied to the fuse element and a filler material is added to the casing so as to support the fuse element. The filler material is then solidified. Next, the mechanical tension is removed with the fuse element retaining a residual tensile stress after removal of the mechanical tension.

A method of fabricating a fuse includes providing a fuse element within a casing. The fuse element has a plurality of ligaments configured to direct a current therethrough. A preload current is then applied to the fuse element and a filler material is added to the casing so as to support the fuse element. The filler material is then solidified. Next, the preload current is removed with the fuse element retaining a residual tensile stress after removal of the preload current.

A fuse for an electric vehicle battery includes a casing, with a first electrical terminal secured to a distal end of the casing and a second electrical terminal secured to a proximal end of the casing. A fuse element is arranged to extend between the distal and proximal ends of the casing. The fuse element includes a plurality of openings arranged between the distal and proximal ends of the casing. The openings define a plurality of ligaments extending therebetween. A filler material surrounds the fuse element and extends through the openings. The filler material is solidified about the fuse element for maintaining a residual tensile stress at the plurality of ligaments.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an exemplary electric storage battery assembly according to the present disclosure;

FIG. 2 is a perspective view of a main vehicle fuse;

FIG. 3A is a schematic view of a fuse element and casing with the fuse element mechanically held in tension;

FIG. 3B is a schematic view of the fuse element and casing of FIG. 3A with filler material added and solidified;

FIG. 3C is a schematic view of the fuse element and casing of FIG. 3A with the mechanical tension removed;

FIG. 4A is a schematic view of another fuse element and casing with a preload current applied to the fuse element;

FIG. 4B is a schematic view of the fuse element and casing of FIG. 4A with filler material added and solidified;

FIG. 4C is a schematic view of the fuse element and casing of FIG. 4A with the preload current removed from the fuse element;

FIG. 5A is a schematic view of another fuse element and casing with an unprocessed thermosetting binder added;

FIG. 5B is a schematic view of the fuse element, casing, and binder of FIG. 5A with a heat source applied to the fuse element;

FIG. 5C is a schematic view of the fuse element, casing, and binder of FIG. 5A with the heat source removed from the fuse element; and

FIG. 6A is a schematic front view of another fuse element and casing; and

FIG. 6B is a schematic side view of the fuse element and casing of FIG. 6A.

### DETAILED DESCRIPTION

The following description is merely exemplary in nature and is not intended to limit the present disclosure, application, or uses. It should be understood that throughout the drawings, corresponding reference numerals indicate like or corresponding parts and features. Further, directions such as “top,” “side,” “back”, “lower,” and “upper” are used for purposes of explanation and are not intended to require specific orientations unless otherwise stated. These directions are merely provided as a frame of reference with respect to the examples provided, but could be altered in alternate applications.

An electric vehicle is propelled by a motor that receives power from an electric storage battery assembly that is designed to provide power over a sustained period of time. The electric storage battery assembly design varies widely by manufacturer and specific application; however, basic required functions are performed by a combination of simple mechanical and electric component systems. In one example, the individual battery cells may have different chemical and/or physical shapes, but they incorporate many discrete cells connected in series and parallel to achieve the total voltage and current requirements. The discrete cells can be joined together to complete the electrical path for current flow. To assist in manufacturing and assembly, the joined cells can then be grouped into modules, which are in turn joined by a main vehicle fuse. The main vehicle fuse can be used to split or limit the current of the electric storage battery assembly under a short circuit condition.

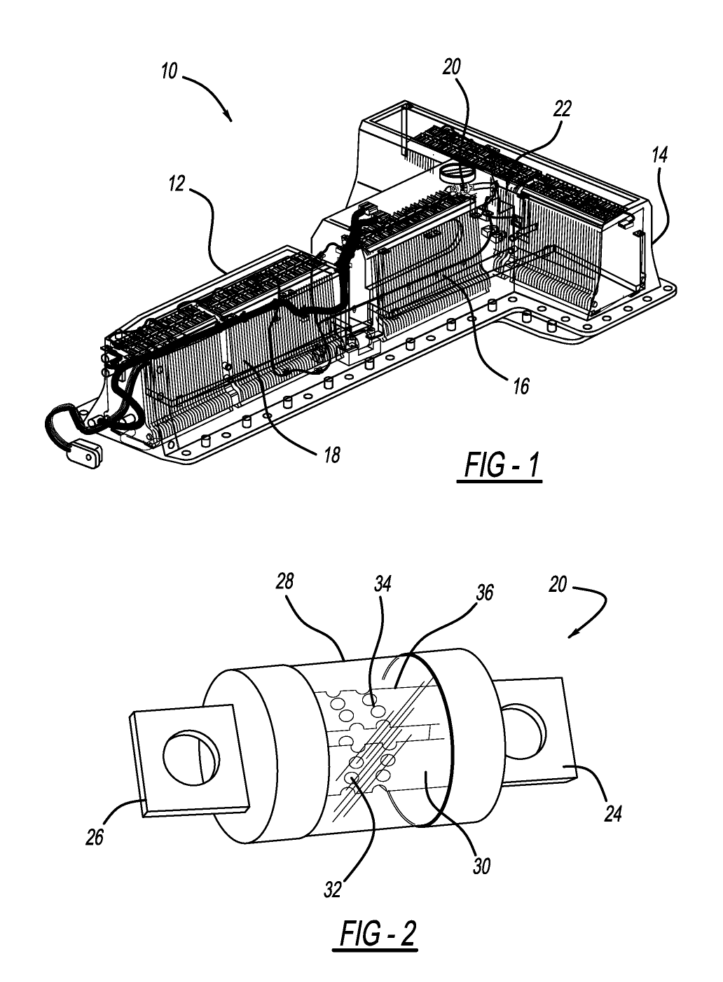

With reference now to FIG. 1, an electric storage battery assembly 10 is shown having a longitudinal leg portion 12 and a cross leg portion 14. The longitudinal leg portion 12 supports first and second battery modules 16, 18, which comprise 72 cells and 90 cells, respectively. A third battery module 22 having 126 cells is supported on the cross leg portion 14. Each battery module 16, 18, 22 includes multiple voltage temperature sub-modules (VTSM) stacked along a length thereof, each module comprising a battery cell, repeating frame, jacket and foam. Each VTSM has a positive tab and a negative tab that is joined to tabs of adjacent VTSMs to sense the voltage flowing between each fully charged battery module (e.g., an output voltage of about 40 to 50 volts). The battery modules can be operatively connected by a main vehicle fuse 20 such that the battery modules are configured to store electrical energy that may be used for operating the vehicle. In the embodiment shown, the main vehicle fuse 20 is operatively connected between the longitudinal and cross leg portions 12, 14; however, it is to be understood that any number of battery modules may be interconnected by the main vehicle fuse 20.

Referring now to FIG. 2, the main vehicle fuse 20 may include first and second electrical terminals 24, 26 enclosing a casing 28. The first electrical terminal 24 may be secured to a distal end of the casing 28 and the second electrical terminal 26 may be secured to a proximal end of the casing 28 by known methods, such as, by welding, soldering, or mechanical fastening. The main vehicle fuse 20 may include a metallic fuse element 30 having perforated openings 32 at a central portion thereof so as to form ligaments 34 joining the first electrical terminal 24 to the second electrical terminal 26. The sheet 30 may be formed by any process for providing a thin profile (e.g., 1 mm thickness), such as by a cold-rolling process, and from a high purity material (e.g., Cu) for providing improved fatigue life and greater conductivity for the main vehicle fuse 20. While the openings 32 are depicted as circular throughout the various figures, it should also be understood that any shape or configuration may be used for the openings (e.g., curved notches, ovals) so as to focus battery current through the ligaments 34 extending therebetween.

The fuse element 30 may also be supported by a filler material 36 arranged within the casing 28. The filler material 36 may be selected from any material that is non-conductive and is able to withstand the electrical load on the main vehicle fuse 20. In this regard, the filler material may be, for example, a sodium silicate, a polymeric composite, a neat or reinforced thermoplastic, or a neat or reinforced thermoset.

The main vehicle fuse 20 may be arranged in series with the battery modules 16, 18, 22 to carry the battery current passing through the circuit. The current flow may be measured via a current-measuring device, such as an ammeter or utilizing other known methods. In the embodiment shown, the resistance of the main vehicle fuse 20 generates heat due to the current flow. If an electrical current exceeding a predefined value flows, the main vehicle fuse 20 rises to a high temperature that may melt the fuse element 30 at the ligaments 34, thereby opening the circuit. While the current overload is a designed failure mode, certain driving maneuvers may also lead to cycles in temperature and stress at the ligaments 34, causing the ligaments 34 to fail mechanically, without excessive current flow. In particular, the ligaments 34 may fail due to buckling and bending at the ligaments 34 and/or due to the compressive fatigue experienced by the fuse element 30. A residual tensile stress maintained in the fuse element 30 will reduce the maximum compressive stress during cyclic loading, thereby increasing the life of the main vehicle fuse 20 without compromising its functionality.

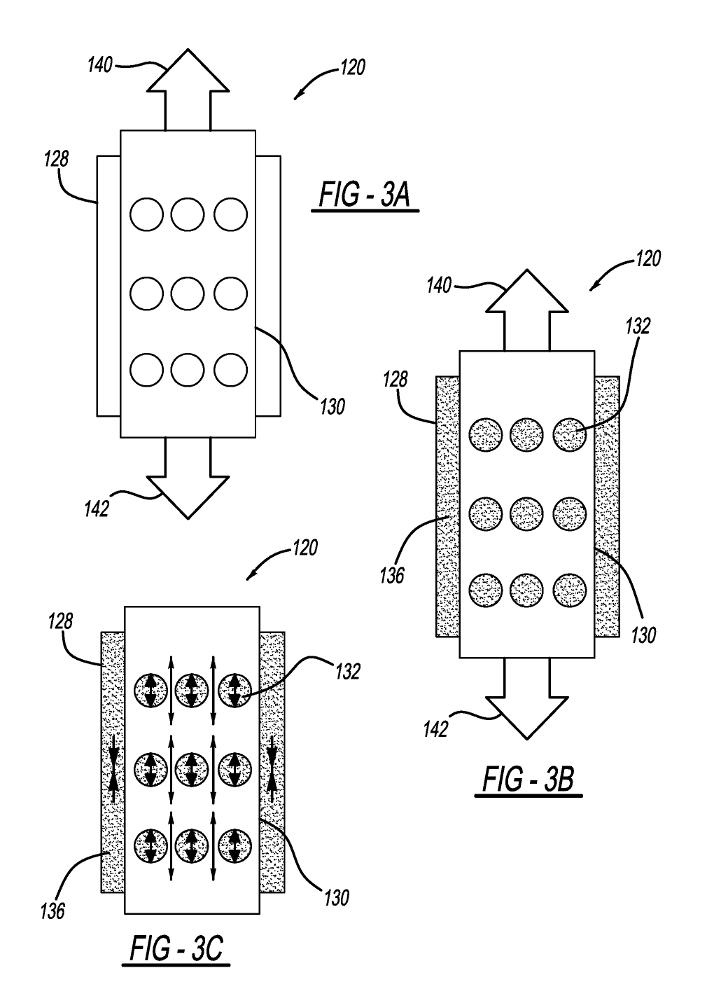

With reference now to FIGS. 3A-3C, a process for imparting a residual tensile stress on a main vehicle fuse 120 is depicted. As shown in FIG. 3A, the fuse element 120 is shown having a casing 128 and a metallic fuse element 130 arranged therein. The fuse element 130 is mechanically held in tension during manufacturing, as shown by arrows 140, 142. Next, as depicted in FIG. 3B, a filler material 136 is added to the casing 128, so as to enclose the fuse element 130 and infiltrate perforated openings 132 therein. The filler material 136 is then solidified, while the tension is still being applied to the fuse element 130. After solidification of the filler material 136, the mechanical tension is removed, leading to residual tensile stresses in the fuse element 120 (see FIG. 3C).

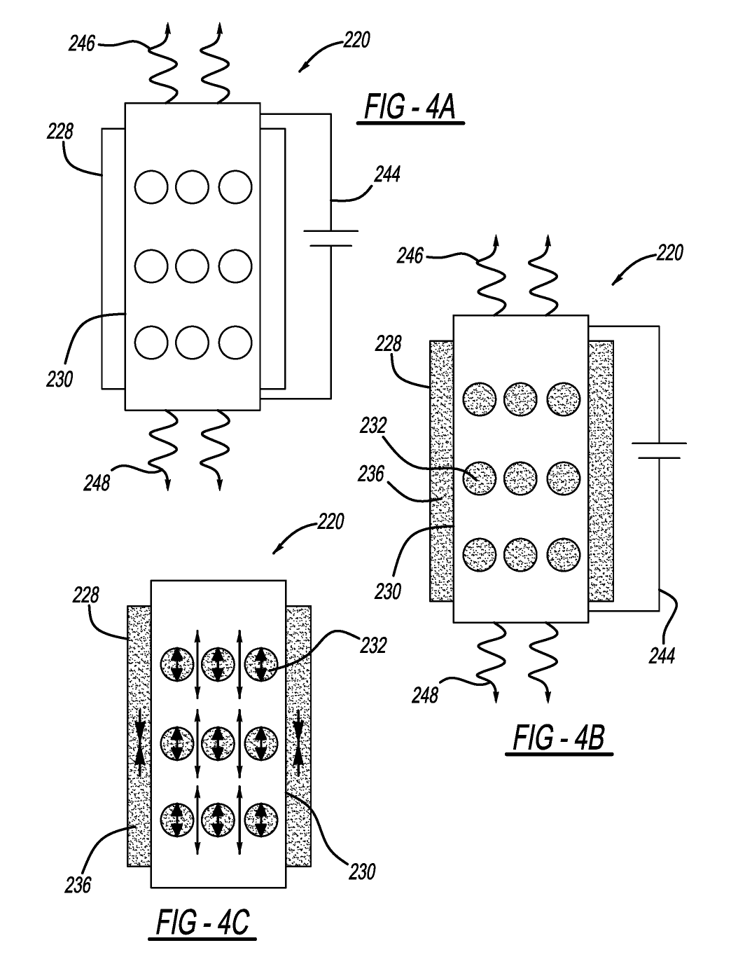

Referring now to FIGS. 4A-4C, another process for imparting a residual tensile stress on a main vehicle fuse 220 is depicted. As shown in FIG. 4A, the main vehicle fuse 220 is shown having a casing 228 and a fuse element 230 arranged therein. The metallic fuse element 230 is heated with a preload current via circuit 244 to cause a thermal expansion of the fuse element 230 in a longitudinal direction, as depicted by arrows 246, 248. Next, as shown in FIG. 4B, a filler material 236 is added to the casing 228, so as to enclose the fuse element 230 and infiltrate perforated openings 232 therein. The filler material 236 is then solidified, while the preload current is still being applied to the fuse element 230. Cooling of the fuse element 230 occurs after the preload current is removed from the fuse element 230. The filler material 236 constrains the fuse element 230 from contracting, leading to residual tensile stresses in the fuse element 230 (see FIG. 4C). It should be understood that while described as being heated solely by the circuit 244, it is also contemplated that a two-stage heating process can be used, where the fuse element 230 is initially heated in a furnace to a predetermined temperature and then a controlled preload current is provided to bring the fuse element 230 and filler material 236 to operating temperature. Likewise, it should be understood that the same effect can be created by cooling the fuse casing 228 and filler material 236 during solidification, while maintaining the fuse element 230 at ambient temperature.

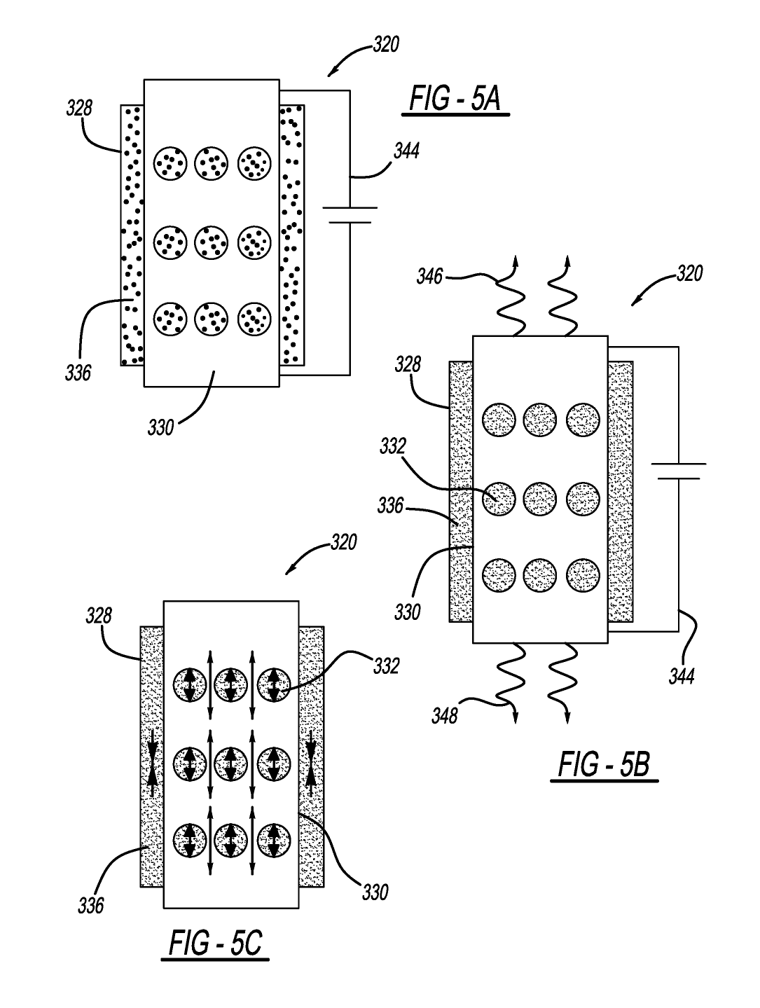

With reference now to FIGS. 5A-5C, yet another process for imparting a residual tensile stress on a main vehicle fuse 320 is depicted. As shown in FIG. 5A, the main vehicle fuse 320 is shown having a casing 328, a metallic fuse element 330, and an unprocessed thermoset material 336 arranged therein (e.g., thermosetting polymer or resin). Next, as shown in FIG. 5B, the fuse element 330 is heated with a preload current via circuit 344 to cause a thermal expansion of the fuse element 330 in a longitudinal direction, as depicted by arrows 346, 348. The applied preload current also causes the thermoset material 336 to set, so as to enclose the fuse element 330 and infiltrate perforated openings 332 therein. As shown in FIG. 5C, cooling of the thermoset material 336 occurs after the preload current is removed from the fuse element 330. The thermoset material 336 constrains the fuse element 330 from contracting, leading to residual tensile stresses in the main vehicle fuse 320. It should be understood that the thermoset material should be selected to have a quick reaction time and high resistivity. The thermoset material should also have a low coefficient of thermal expansion in order to create residual tensile stresses in the metallic fuse sheet.

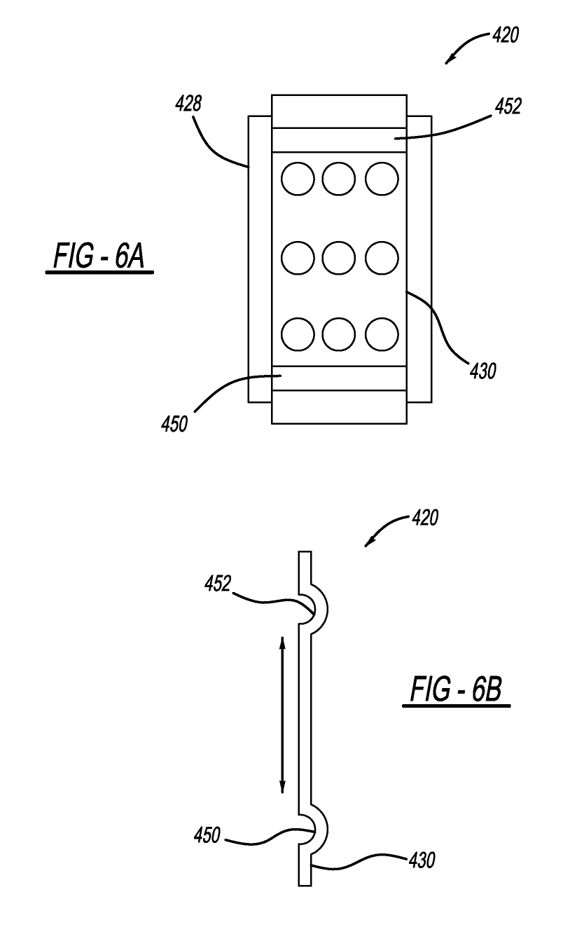

Referring now to FIGS. 6A and 6B, still another process for imparting a residual tensile stress on a main vehicle fuse 420 is depicted. The main vehicle fuse 420 is shown having a casing 428 and a metallic fuse element 430 arranged therein. The metallic fuse element 430 is provided with a pair of protrusions 450, 452 in order to mechanically support a tensile stress in the metallic fuse element 430. In some embodiments, a thermoset material can be applied to the protrusions 450, 452, which shrinks as it sets in order to impart further tensile stress on the metallic fuse element 430.

Embodiments of the present disclosure are described herein. This description is merely exemplary in nature and, thus, variations that do not depart from the gist of the disclosure are intended to be within the scope of the disclosure. For example, while each of the multiple embodiments describe heating of the fuse element for expansion thereof, it should be understood that compressing the casing through a cooling operation is also contemplated. Additionally, the figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for various applications. Various combinations and modifications of the features consistent with the teachings of this disclosure, however, could be desired for particular applications or implementations.

What is claimed is:

1. A method of fabricating a fuse comprising:
providing a fuse element within a casing, the fuse element having a plurality of ligaments configured to direct a current therethrough;
applying a mechanical tension to the fuse element;
adding a filler material to the casing so as to support the fuse element;
solidifying the filler material; and
removing the mechanical tension, wherein the fuse element retains a residual tensile stress after removal of the mechanical tension.

2. The method of fabricating the fuse of claim 1, wherein the fuse element has a predetermined failure mode at at least one of the plurality of ligaments when an overcurrent flows therethrough.

3. The method of fabricating the fuse of claim 1, further comprising:
a first electrical terminal secured at a distal end of the casing; and
a second electrical terminal secured at a proximal end of the casing, wherein the first and second electrical terminals are secured to a battery for focusing battery current through the fuse element.

4. The method of fabricating the vehicle fuse of claim 1, wherein the filler material is non-conductive.

5. The method of fabricating the vehicle fuse of claim 1, wherein the filler material is reinforced with a glass fiber.

6. A method of fabricating a fuse comprising:
providing a fuse element within a casing, the fuse element having a plurality of ligaments configured to direct a current therethrough;
applying a preload current to the fuse element;
adding a filler material to the casing so as to support the fuse element;
solidifying the filler material; and
removing the preload current, wherein the fuse element retains a residual tensile stress after removal of the preload current.

7. The method of fabricating the fuse of claim 6, further comprising:
a first electrical terminal secured at a distal end of the casing; and
a second electrical terminal secured at a proximal end of the casing, wherein the first and second electrical terminals are secured to a battery to focus the battery current through the fuse element.

8. The method of fabricating the fuse of claim 6, wherein the filler material is an unprocessed thermoset material that is added prior to applying the preload current, and wherein the preload current causes the thermoset material to solidify.

9. The method of fabricating the fuse of claim 6, wherein the fuse element has a predetermined failure mode at at least one of the plurality of ligaments when an overcurrent flows therethrough.

10. The method of fabricating the fuse of claim 6, wherein the filler material is non-conductive.

11. The method of fabricating the fuse of claim 6, wherein the filler material is reinforced with a glass fiber.

12. A fuse for an electric vehicle battery, the fuse comprising:
a casing;
a first electrical terminal secured to a distal end of the casing and a second electrical terminal secured to a proximal end of the casing; and
a fuse element arranged to extend between the distal and proximal ends of the casing, wherein the fuse element further comprises:
a plurality of openings arranged between the distal and proximal ends of the casing, the openings defining a plurality of ligaments extending therebetween;
a filler material surrounding the fuse element and extending through the openings, wherein the filler material is solidified about the fuse element for maintaining a residual tensile stress at the plurality of ligaments.

13. The fuse of claim 12, wherein the filler material is non-conductive.

14. The fuse of claim 12, wherein the filler material is an unprocessed thermoset material that is added prior to applying a preload current, and wherein the preload current causes the thermoset material to solidify.

15. The fuse of claim 12, wherein the fuse element is configured to fail at at least one of the plurality of ligaments when an overcurrent flows therethrough.

16. The fuse of claim 12, further comprising a first protrusion on a surface of the fuse element arranged between the distal end of the casing and the plurality of openings and a second protrusion on the surface of the fuse element arranged between the proximal end of the casing and the plurality of openings.

17. The fuse of claim 16, wherein the filler material is arranged within the first and second protrusions.

18. The fuse of claim 12, wherein the first electrical terminal is configured to be secured to a first battery module and the second electrical terminal is configured to be secured to a second battery module, wherein the first and second electrical terminals are configured to focus the battery current through the fuse element.

19. The fuse of claim 12, wherein the plurality of openings are one of a rounded notch, a circular hole, or an ovular hole.

20. The fuse of claim 12, wherein the filler material is reinforced with a glass fiber.
